(19) United States
(12) Patent Application Publication
(10) Pub. No.: US 2023/0282390 A1
(43) Pub. Date: Sep. 7, 2023

(54) FLEXIBLE FLAT CABLE

(71) Applicant: BELLWETHER ELECTRONIC CORP., Taoyuan City (TW)

(72) Inventors: HSING-YU LEE, Taoyuan City (TW); KUAN-WU CHEN, Taoyuan City (TW)

(21) Appl. No.: 17/733,848

(22) Filed: Apr. 29, 2022

(30) Foreign Application Priority Data
Mar. 7, 2022 (TW) 111108230

(51) Int. Cl. H01B 7/08; H01B 7/18; H01B 3/42

(52) U.S. Cl. CPC H01B 7/0838; H01B 7/188; H01B 7/183; H01B 3/421

(57) ABSTRACT

A flexible flat cable includes a low-dielectric adhesive layer, a plurality of conductors, two shielding layers and two insulating protective layers. These conductors are located inside the low-dielectric adhesive layer and are spaced apart. The two shielding layers are laminated individually to the upper and lower surfaces of the low-dielectric adhesive layer. The two insulating protective layers are laminated individually to the two shielding layers.

### BACKGROUND OF THE INVENTION

### 1. Field of the Invention

The present invention relates to a cable, in particular to a flexible flat cable resistant to folding.

### 2. Description of the Related Art

It is not uncommon that a conventional flexible flat cable (FFC), when used in practice, is folded or needs to be folded. In this case, the insertion loss and characteristic impedance of the FFC often change significantly due to being folded, thereby affecting the transmission characteristics of the FFC. In other words, the FFC originally has good transmission characteristics (or meets transmission characteristics requirements) when it is not folded. It is often difficult for the FFC to maintain good transmission characteristics once it is folded.

Therefore, providing an FFC that can still maintain good transmission characteristics after being folded is an urgent need.

### SUMMARY OF THE INVENTION

It is the object of the present invention to provide a flexible flat cable (FFC) to solve the aforementioned problem. More specifically, the flexible flat cable of the present invention comprises a low-dielectric adhesive layer, a plurality of conductors, two shielding layers, and two insulating protective layers. These conductors are located inside the low-dielectric adhesive layer and arranged side by side with space in between. The two shielding layers are laminated individually and directly to upper and lower surfaces of the low-dielectric adhesive layer. The two insulating protective layers laminated individually to the two shielding layers.

In a preferred embodiment, the low-dielectric adhesive layer has one or more of the following properties:
Shore A hardness: 50-90;
Melting point: 95-180° C.; and
Water absorption: 0.001-1%.

In another preferred embodiment, the thickness of the low-dielectric adhesive layer is 100-450 μm, the thickness of each shielding layer is 0.003˜0.020 mm, and the thickness of each insulating protective layer is 0.005˜0.05 mm.

The present invention also provides a flexible flat cable comprises of two polyester insulating tape bodies and a plurality of conductors arranged side by side. Each of the polyester insulating tape body includes an insulating protective layer, a low-dielectric adhesive material, and a shielding layer sandwiched between the insulating protective layer and the low-dielectric adhesive material layer. The conductors are sandwiched between the low-dielectric adhesive material of one of the polyester insulating tape bodies and the low-dielectric adhesive material of the other polyester insulating tape body.

In one preferred embodiment, the total thickness of the two low-dielectric adhesive materials of the flexible flat cable of the present invention is 100-450 μm, the thickness of each shielding layer is 0.003˜0.020 mm, and the thickness of each insulating protective layer is 0.005˜0.05 mm.

In another preferred embodiment, the aforementioned low-dielectric adhesive material of the flexible flat cable is selected from the group consisting of polyester, polyimide, fluoropolymer, polyolefin, polyurethane, epoxy resin, thermoplastic rubber, ethylene-vinyl acetate copolymer and polyvinyl alcohol.

In yet another preferred embodiment, the cross-sectional shape of each of the conductors of the present invention is circular, with a diameter being 25-40 AWG, internal impedance being 65-110 ohms, and a center-to-center distance between two adjacent conductorsbeing 0.3-0.8 mm.

The present invention further provides a flexible flat cable comprises an adhesive layer, two shielding layers, two protective layers, and a plurality of conductors. The two shielding layers are individually and directly laminated to the upper and lower surfaces of the adhesive layer. The two protective layers are individually laminated to the two shielding layers. The plurality of conductors are located inside the adhesive layer and arranged side by side with space in between. Wherein the dielectric constant of the adhesive layer is 1.5-3, and the thickness thereof is 100-450 μm.

In a preferred embodiment, the Shore A hardness of the adhesive layer is 50-90.

In another preferred embodiment, the melting point of the adhesive layer is 95-180° C.

In summary, compared with the prior art, the insertion loss and characteristic impedance of the flexible flat cable of the present invention do not change significantly before and after the cable is folded, thereby allowing the cable to maintain its original good transmission characteristics when folded, thus solving the problem with conventional flexible flat cable being unable to maintain good transmission when the cable is folded.

### BRIEF DESCRIPTION OF THE DRAWINGS

FIG. 1 is an enlarged schematic partial cross-sectional view of a preferred embodiment of the FFC of the present invention;

FIG. 2 is a schematic plan view of the preferred embodiment of the present invention;

FIG. 3 is a schematic plan view of the preferred embodiment of the present invention being folded into an N shape;

FIG. 4 is a schematic diagram depicting the fabrication of the preferred embodiment of the present invention;

FIG. 5 is an enlarged partial cross-sectional view of the polyester insulating tape body 100 of the preferred embodiment of the present invention;

FIG. 6 is an insertion loss vs. frequency graph for the preferred embodiment of the present invention when it is not yet folded and when it is folded into an N shape;

FIG. 7 is a characteristic impedance vs. time graph for the preferred embodiment of the present invention when it is not yet folded and when it is folded into an N shape.

### DETAILED DESCRIPTION OF EMBODIMENTS

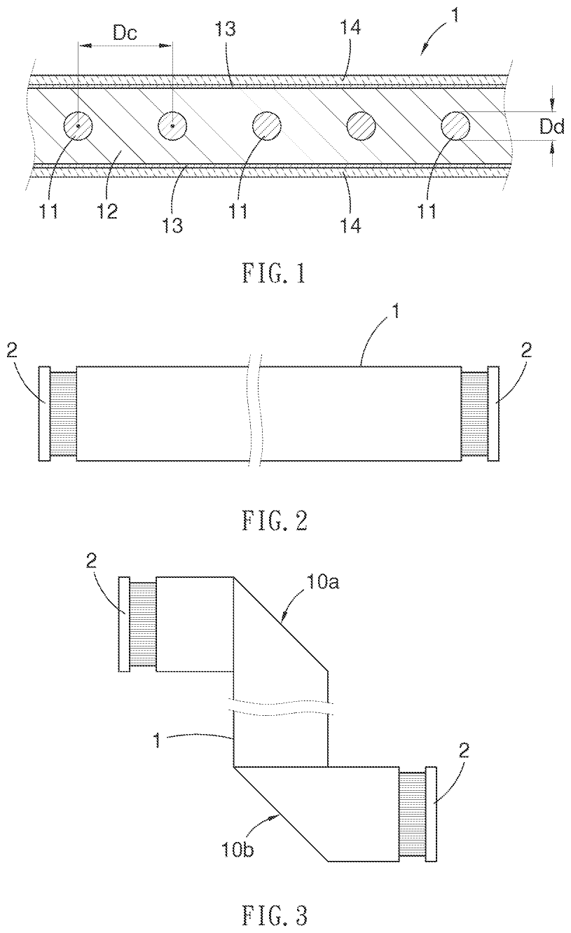

FIG. 1 and FIG. 2 are schematic views showing a preferred embodiment of the FFC 1 of the present invention. Each of the two ends of the cable has an electrical connector 2, and the two electrical connectors 2 are used for plugging individually into two electronic devices (not shown in the figures), so that the two electronic devices can transmit signals through the FFC 1. Any of said electrical connectors 2 can also be connected with corresponding mating electrical connectors to form an electrical connection. In addition, FIG. 3 shows a possible usage of the FFC 1, in which the FFC 1 is folded into an N shape so as to form a first folded edge 10a and a second folded edge 10b.

As shown in FIG. 1, the layered structure of the FFC 1 of the present invention includes a low-dielectric adhesive layer 12, a plurality of conductors 11 located inside the low-dielectric adhesive layer 12 and arranged side by side with space in between, two shielding layers 13 laminated individually and directly to the upper and lower surfaces of the low-dielectric adhesive layer 12, and two insulating protective layers 14 laminated to the two shielding layers 13. The low-dielectric adhesive layer 12 is not limited to being composed of a mixture of a low-dielectric material and an adhesive material, but it can also be an adhesive layer formed by mixing another dielectric material and adhesive material, or an adhesive layer simply composed of an adhesive material.

The low dielectric adhesive layer 12 may be composed of one layer of low dielectric adhesive material 121 (see FIG. 5), or may be composed of a plurality of layers of low dielectric adhesive material 121. No matter how it is formed, the thickness of the low-dielectric adhesive layer 12 is preferably, but not limited to, 100-450 μm±10 μm. Said low-dielectric adhesive material 121 can preferably be selected from, but not limited to, the group consisting of polyester, polyimide, fluoropolymer, polyolefin, polyurethane, epoxy resin, thermoplastic rubber (TPR), ethylene vinyl acetate copolymer (EVA), and polyvinyl alcohol (PVA). In addition, the low dielectric adhesive layer 12 has at least one or more of the following properties:
Operating temperature: 50-150° C.;
Shore A hardness: 50-90;
Dielectric constant (Dk): 1.5-3;
Dissipation factor (Df): 0.0001-0.01;
Melting point: 95-180° C.;
Water absorption: 0.001-1%.

The cross-sectional shape of each of the conductors 11 can be circular, rectangular, square or other shapes. In this preferred embodiment, the cross-sectional shape of each of the conductors 11 is circular with a diameter Dd being preferably 25-40 AWG, internal impedance being preferably 65-110 ohms, and a center-to-center distance between two adjacent conductors 11 being preferably 0.3-0.8 mm.

The thickness of each of the shielding layers 13 is preferably 0.003-0.020 mm.

Each of the conductors 11 and each of the shielding layers 13 are made of conductive materials, such as copper, silver, aluminum, gold or alloys thereof, but not limited thereto.

The thickness of each of the insulating protective layers 14 is preferably 0.005-0.05 mm, and the material thereof is preferably thermoplastic or thermosetting insulating material. In addition, each of the insulating protection layers 14 can be bonded to the adjacent shielding layers 13 by an adhesive layer (not shown in the figures).

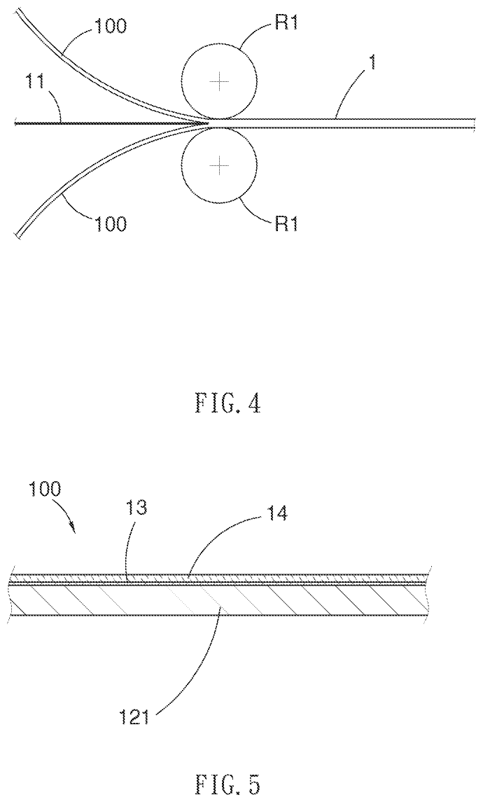

FIG. 4 shows that the conductors 11 are introduced between the two pre-fabricated polyester insulating tape bodies 100, and then the two polyester insulating tape bodies 100 are pressed by two hot press rollers R1 to obtain the FFC 1 of the present invention. As shown in FIG. 5, the layered structure of each polyester insulating tape body 100 includes a layer of the insulating protection layer 14, a layer of the shielding layer 13 and a layer of the low-dielectric adhesive material 121. The shielding layer 13 is sandwiched between the other two, preferably the shielding layer 13 being directly laminated to the surface of the low-dielectric adhesive material 121. When the conductors 11 arranged side by side with space in between are introduced between the two polyester insulating tape bodies 100, the low-dielectric adhesive material 121 of one of the polyester insulating tape bodies 100 faces an upper surface of each of the conductors 11, while the low-dielectric adhesive material 121 of the other polyester insulating tape body 100 faces a lower surface of each of the conductors 11. Therefore, when two of the polyester insulating tape bodies 100 are pressed by the two hot press rollers R1, the low-dielectric adhesive material 121 of one of the polyester insulating tape bodies 100 will be bonded to the low-dielectric adhesive materials 121 of the other polyester insulating tape body 100, so that the conductors 11 are surrounded by two of the low-dielectric adhesive materials 121; in other words, the conductors 11 are located inside the low-dielectric adhesive layer 12 formed by two of the low-dielectric adhesive materials 121.

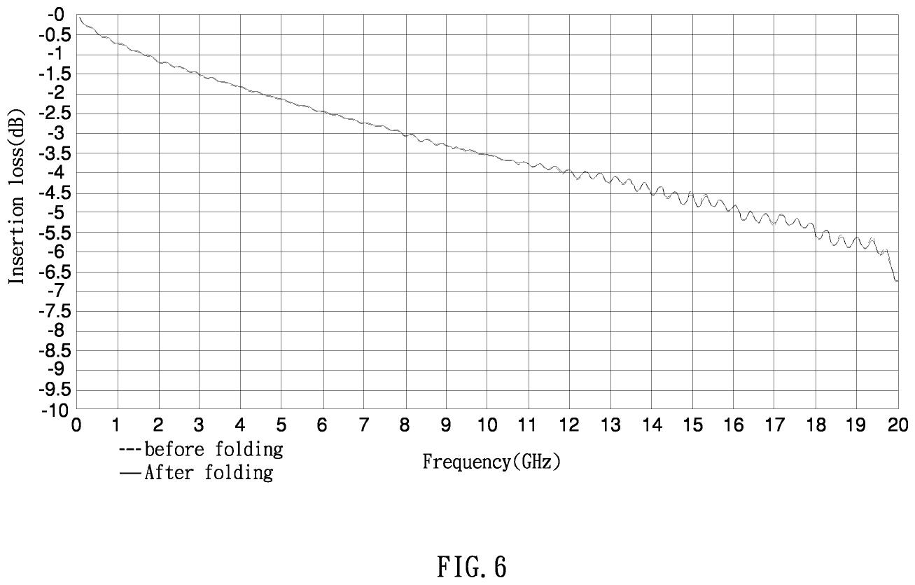

FIG. 6 shows an insertion loss vs. frequency graph for said FFC 1 of the present invention when it is not folded and when it is folded into an N shape (see FIG. 3). It can be seen from the figure that the two curves almost overlap, which means that the insertion loss of said FFC 1 of the present invention does not decrease significantly when it is folded into an N shape compared to the insertion loss when it is not folded. This shows that regardless of the frequency, the insertion loss of said FFC 1 of the present invention is not affected even when the cable is folded.

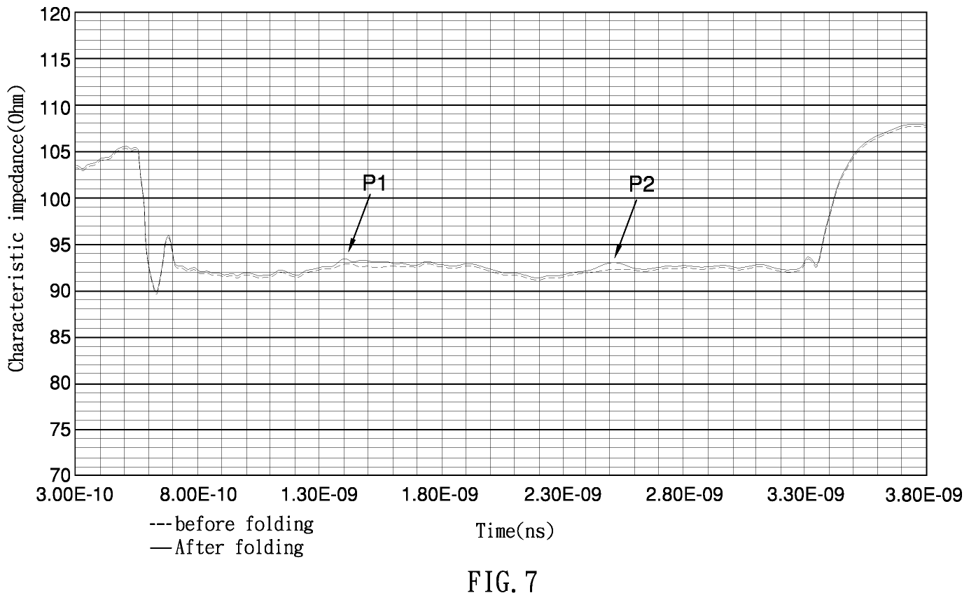

FIG. 7 shows a characteristic impedance vs. time graph for FFC 1 of the present invention when it is not folded and when it is folded into an N shape (see FIG. 3). It can be seen from the figure that at the two positions P1 and P2 corresponding to said first folded edge 10a and said second folded edge 10b, the maximum change in the characteristic impedance is only about 1 ohm. This shows that not much impedance change is caused even when the FFC 1 of the present invention is folded.

Regarding the above descriptions, the conductor of the present invention is located inside an adhesive layer, the two shielding layers being directly laminated to the upper and lower surfaces of the adhesive layer, and a protective layer is laminated to each of the shielding layers. Therefore, between each of the shielding layers and the conductors, there is no film layer of other materials except the adhesive layer therebetween. As such, the insertion loss and characteristic impedance of said FFC 1 of the present invention do not change significantly before and after the cable is folded, thereby allowing the cable to maintain its original good transmission characteristics when folded.

1. A flexible flat cable (FFC), comprising:
a single low-dielectric adhesive layer composed of a mixture of a low-dielectric material and an adhesive material;
a plurality of conductors which are spaced apart sheathed in the low-dielectric adhesive layer;
two shielding layers composed of a conductive material laminated individually and directly to upper and lower surfaces of the low-dielectric adhesive layer; and;
two insulating protective layers laminated individually to the two shielding layers.

2. The FFC as recited in claim 1, wherein the low-dielectric adhesive layer has one or more of the following properties:
Shore A hardness: 50-90;
Melting point: 95-180° C.; and
Water absorption: 0.001-1%.

3. The FFC as recited in claim 1, wherein the thickness of the low-dielectric adhesive layer is 100-450 μm.

4. (canceled)

5. The FFC as recited in claim 1, wherein the low-dielectric material is selected from the group consisting of polyester, polyimide, fluoropolymer, polyolefin, polyurethane, epoxy resin, thermoplastic rubber, ethylene-vinyl acetate copolymer and polyvinyl alcohol.

6. The FFC as recited in claim 1, wherein a cross-sectional shape of each of the conductors is circular, with a diameter being 25-40 AWG, an internal impedance being 65-110 ohms, and a center-to-center distance between two adjacent conductors being 0.3-0.8 mm.

7. A flexible flat cable (FFC), comprising:
two polyester insulating tape bodies, each of the polyester insulating tape bodies including an insulating protective layer, a single low-dielectric adhesive layer composed of a mixture of a low-dielectric material and an adhesive material, and a shielding layer composed of a conductive material sandwiched between the insulating protective layer and the low-dielectric adhesive layer, the shielding layer being directly laminated to the low-dielectric adhesive layer; and
a plurality of conductors spaced apart and being sandwiched between the low-dielectric adhesive layer of one of the polyester insulating tape bodies and the low-dielectric adhesive layer of the other polyester insulating tape body.

8. The FFC as recited in claim 7, wherein the low-dielectric material is selected from the group consisting of polyester, polyimide, fluoropolymer, polyolefin, polyurethane, epoxy resin, thermoplastic rubber, ethylene-vinyl acetate copolymer and polyvinyl alcohol.

9. The FFC as recited in claim 7, wherein a cross-sectional shape of each of the conductors is circular, with a diameter being 25-40 AWG, an internal impedance being 65-110 ohms, and a center-to-center distance between two adjacent conductors being 0.3-0.8 mm.

10. The FFC as recited in claim 7, wherein a total thickness of the two low-dielectric adhesive materials is 100-450 μm.

11. A flexible flat cable (FFC), comprising:
a single adhesive layer;
two shielding layers composed of a conductive material, individually and directly laminated to upper and lower surfaces of the adhesive layer;
two protective layers, individually laminated to the two shielding layers; and
a plurality of conductors which are spaced apart sheathed in the adhesive layer;
wherein the dielectric constant of the adhesive layer is 1.5-3, and the thickness thereof is 100-450 μm.

12. The FFC as recited in claim 11, wherein the Shore A hardness of the adhesive layer is 50-90.

13. The FFC as recited in claim 11, wherein the melting point of the adhesive layer is 95-180° C.

14. The FFC as recited in claim 11, wherein a center-to-center distance between two adjacent conductors being 0.3-0.8 mm.

15. The FFC as recited in claim 11, wherein a thickness of each protective layer is 0.005-0.05 mm.

16. The FFC as recited in claim 11, wherein a thickness of each shielding layer is 0.003-0.020 mm.
